(19) United States
(12) Patent Application Publication
(10) Pub. No.: US 2026/0202959 A1
(43) Pub. Date: Jul. 16, 2026

(54) INPUT DEVICE AND IMAGE FORMING APPARATUS

(71) Applicant: Kota SHIODERA, Tokyo (JP)

(72) Inventor: Kota SHIODERA, Tokyo (JP)

(73) Assignee: ETRIA CO., LTD., Yokohama (JP)

(21) Appl. No.: 19/384,592

(22) Filed: Nov. 10, 2025

(30) Foreign Application Priority Data
Jan. 10, 2025 (JP) 2025-004279

(51) Int. Cl. G06F 3/0488; G06F 3/041; G06F 3/0482; H04N 1/00

(52) U.S. Cl. CPC G06F 3/0488; G06F 3/0416; G06F 3/0482; H04N 1/00411; G06F 2203/04108

(57) ABSTRACT

An input device includes a display, a touch input device, a touchless detector, and circuitry. The touch input device has a body and a touch region partially overlapping the display face of the display when viewed from a normal direction normal to the display face of the display. The touch input device receives a touch or a press to input operations in the touch region in a touch mode. The touchless detector is attached to the body of the touch input device and detects a touchless input in a touchless region covering a switching region outside the touch region in a touchless mode. The circuitry is configured to determine whether the touchless detector has detected the touchless input in the switching region, and switch from the touch mode to the touchless mode when it is determined that the touchless detector has detected the touchless input as a switching operation.

### CROSS-REFERENCE TO RELATED APPLICATIONS

This patent application is based on and claims priority pursuant to 35 U.S.C. §119(a) to Japanese Patent Application No. 2025-004279, filed on Jan. 10, 2025, in the Japan Patent Office, the entire disclosure of which is hereby incorporated by reference herein.

### BACKGROUND

### Technical Field

The present disclosure relates to an input device and an image forming apparatus.

### Related Art

An input device in the related art includes a display and a touch input device disposed to overlap the display at least partially when viewed in a direction of a normal to the display. The touch input device receives a touch input operation based on a touch or pressing. The input device enables switching between touch input using the touch input device and touchless input.

### SUMMARY

The present disclosure described herein provides an input device that enables switching between touchless input and touch input. The input device includes a display and an touch input device. The touch input device is disposed to overlap the display at least partially when viewed in a direction of a normal to the display, to receive an operation of the touch input based on a touch or pressing. A touchless detector is attached to a main body of the input device to detect a touchless switching operation that is a touchless operation for the switching. The touchless switching operation is performed at a predetermined location that does not overlap the touch input device when viewed in a direction of a normal to the touch input device.

The present disclosure described herein provides an input device including an operation panel. The operation panel includes a display to display information related to image formation; a touch operation device disposed above the display to generate input information in response to a touch or pressing on a surface of the touch operation device; a fixing portion to which the touch operation device is attached; a touchless sensor attached to the operation panel to detect a position of a finger in a touchless manner; a touchless detection surface to detect a position of an object with the touchless sensor; and a touchless switching operation surface where a touch/touchless switching operation is performed in a touchless manner. The touchless switching operation surface is located outside the touch operation device.

The present disclosure described herein provides an image forming apparatus including each of the input devices described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus according to an embodiment of the present disclosure;

FIG. 2 is a perspective view of an operation panel of the image forming apparatus;

FIG. 3 is a perspective view of a detection surface of a touchless operation sensor of the image forming apparatus;

FIG. 4 is a functional block diagram of the operation panel of the image forming apparatus;

FIG. 5 is a flowchart of control performed by the image forming apparatus;

FIGS. 6A and 6B illustrate a configuration example of the operation panel of the image forming apparatus;

FIGS. 7A and 7B illustrate another configuration example of the operation panel of the image forming apparatus;

FIGS. 8A and 8B illustrate still another configuration example of the operation panel of the image forming apparatus;

FIG. 9 illustrates still another configuration example of the operation panel of the image forming apparatus;

FIG. 10 illustrates still another configuration example of the operation panel of the image forming apparatus;

FIG. 11 illustrates still another configuration example of the operation panel of the image forming apparatus; and

FIG. 12 illustrates still another configuration example of the operation panel of the image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An input device in the related art includes a display that displays information related to image formation. The input device detects the position of a pointing body such as a user's finger or a stylus, at a location that is separate from the surface of the display by a predetermined distance in a direction perpendicular to the surface of the display, to receive touchless input. This input device uses a touchless operation unit for an operation of switching between touch input and touchless input.

The display displays the information related to image formation and icons for guiding various operations. Touch input and touchless input are switched between by touchless input. If the touchless input is performed at a location that overlaps the display displaying such icons when viewed in a direction of the normal to the surface of the display, the following issue arises. Specifically, the display desirably displays an icon or the like for guiding an operation for switching between touch input and touchless input. Such a display for the touchless switching operation consumes an area of the display having a limited size.

With the embodiments of the present disclosure, an area of the display is not consumed for a touchless switching operation.

An input device according to an embodiment of the present disclosure used in an operation panel of an image forming apparatus will be described below.

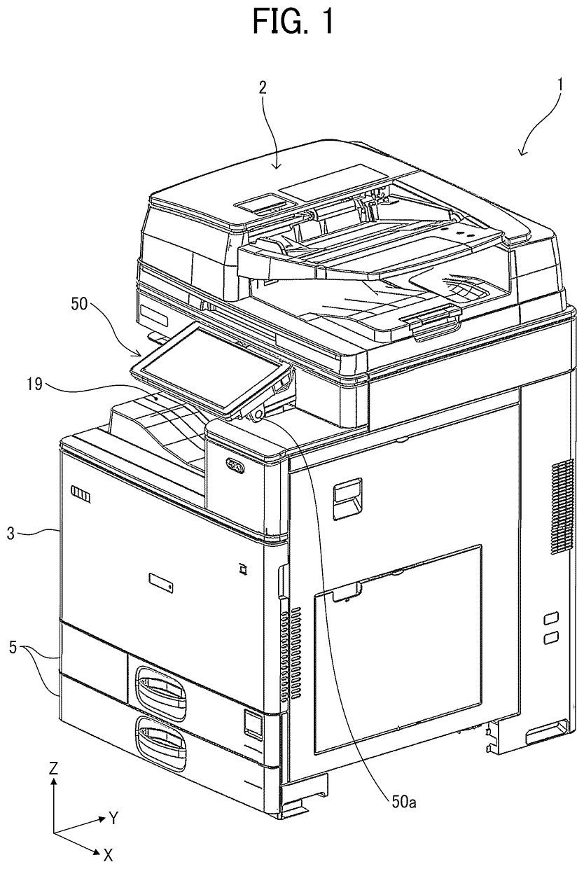

FIG. 1 is a perspective view of an image forming apparatus 1 according to the present embodiment.

The image forming apparatus 1 is a copier in which an image reading device 2 is disposed above an image forming apparatus main body 3. The image forming apparatus main body 3 includes a recording sheet accommodating section 5 and an image forming section (image formation section). The recording sheet accommodating section 5 accommodates a recording sheet that serves as a recording medium on which an image is to be formed. The image forming section serves as an image forming device.

The image forming apparatus 1 includes an operation panel 50 that is installed at a front face thereof (i.e., a face in front of a user who performs ordinary operations). The operation panel 50 is an input device that receives various input operations related to an image forming operation from the user and displays information related to the image forming operation. The operation panel 50 is rotatably supported by a support shaft 50a, and thus has a variable inclination angle.

For example, the image forming section includes an exposure unit serving as an exposure device, multiple photoconductor drums, a developing device that uses toner of four colors that are cyan (C), magenta (M), yellow (Y), and black (K), a transfer belt serving as an intermediate transfer body, a secondary transfer unit, and a fixing unit. This image forming section forms an image based on print data of a read image of an original read by the image reading device 2 or print data transmitted from an external apparatus such as a personal computer (PC) in the following manner, for example. The image forming section exposes, with the exposure unit, a photoconductor drum of each color to light based on the print data to form an electrostatic latent image on each photoconductor drum. The image forming section supplies, with a developing unit of each color of the developing device, toner to the electrostatic latent image on a corresponding photoconductor drum to develop the electrostatic latent image into a toner image. The image forming section transfers the developed toner images on the respective photoconductor drums of the respective colors onto the transfer belt (i.e., primary transfer). The image forming section transfers a superimposed image of the toner images on the transfer belt, onto a recording sheet serving as a recording medium at the secondary transfer unit (i.e., secondary transfer). The image forming section applies, with the fixing unit, heat and pressure to the toner image on the recording sheet to form a color image. The recording sheet having the color image formed thereon is ejected to a sheet ejection tray 19 on the upper face of the image forming apparatus main body 3.

In recent years, there has been an increasing demand for touchless operations for a touch panel and buttons that are touched by many unspecified users, in order to avoid contact with viruses and bacteria that cause infectious diseases. The operation panel 50 of the image forming apparatus 1 installed on a floor such as the image forming apparatus 1 illustrated in FIG. 1 is also operated by many unspecified users. Thus, a certain number of users feel psychologically reluctant to touch the operation panel 50.

Accordingly, the operation panel 50 according to the present embodiment includes a touchless sensor to enable touchless operations for an operation screen.

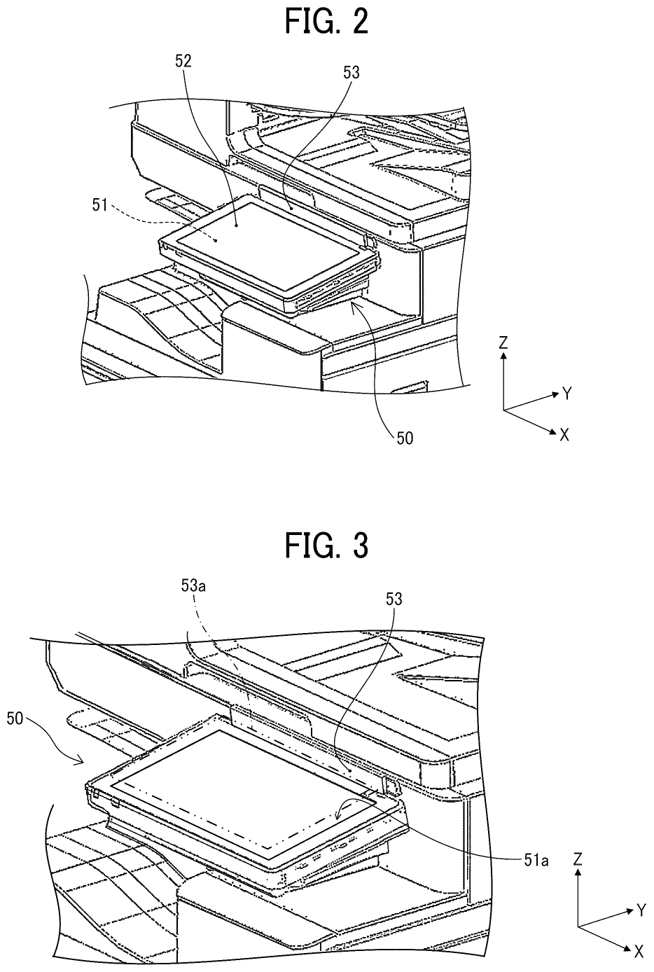

FIG. 2 is a perspective view of the operation panel 50.

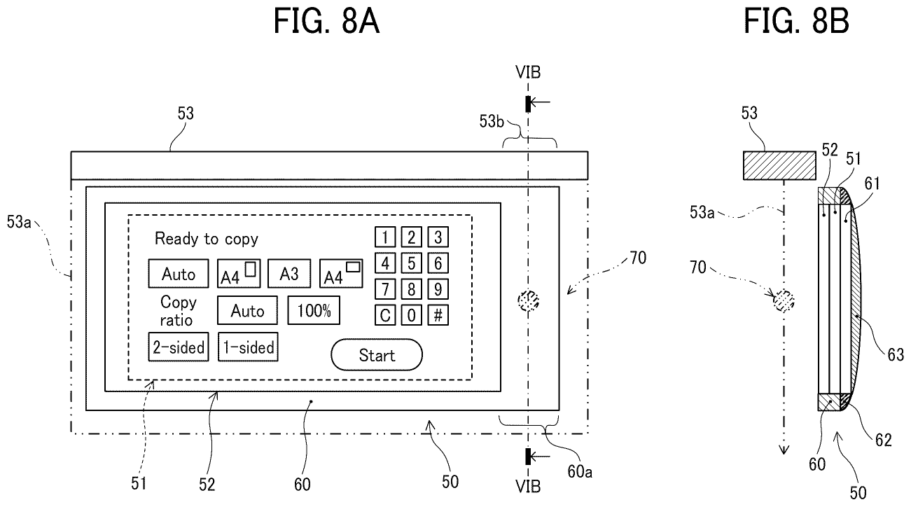

As illustrated in FIG. 2, the operation panel 50 includes a display 51 such as a liquid crystal display (LCD) or a cathode ray tube (CRT) display, and a touch panel 52 serving as a touch input device. For example, as illustrated in FIG. 8B, the operation panel 50 includes a stacked assembly of the touch panel 52, a front cover 60, the display 51 including a liquid crystal panel (liquid crystal panel unit), a printed circuit board (PCB, i.e., a substrate), a bracket 61, a rear cover 62, hinges for attachment to the image forming apparatus, and a back cover 63.

The touch panel 52 is a capacitive or pressure-sensitive touch sensor and is disposed to overlap the display 51. For example, the touch panel 52 is fixed to the front cover 60 with a double-sided tape or the like. The bracket 61 supports the front cover 60, the display 51, and the PCB (substrate). The touch panel 52 has a detection surface for detecting a touch, and detects a touched position in response to a user's finger or the like touching the detection surface.

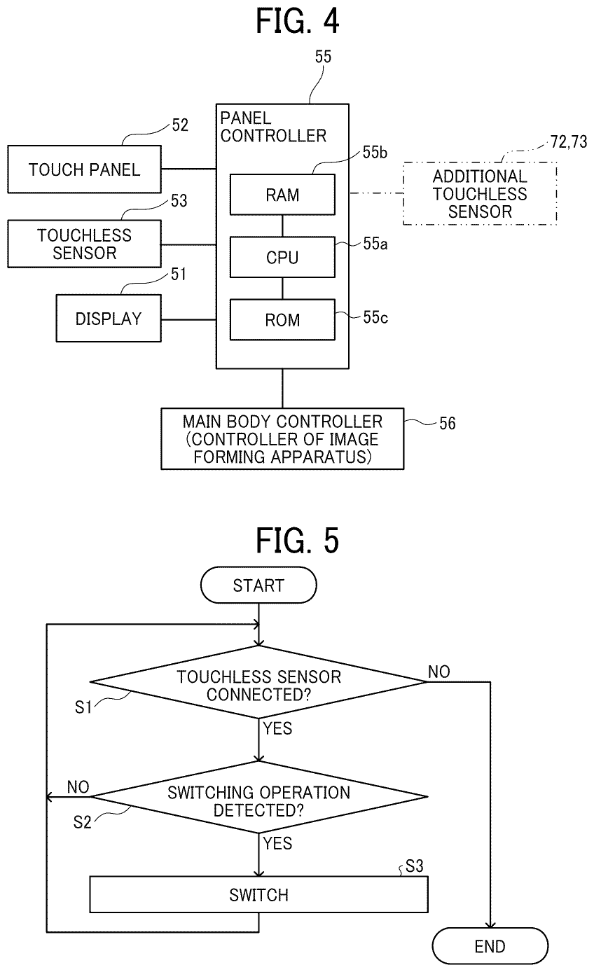

The operation panel 50 also includes a touchless sensor 53 serving as a touchless detector. The touchless sensor 53 is removably attached to the operation panel 50 as a touchless operation unit. Specifically, the touchless sensor 53 is attached to a portion of the operation panel 50 on the far side from the user as an optional component. The touchless sensor 53 is connected to a connection terminal such as a Universal Serial Bus (USB) terminal provided at a bottom portion of the operation panel 50 to receive power supply and communicate with a panel controller 55 (see FIG. 4) that controls the operation panel 50.

The touchless sensor 53 includes optical units arranged in an array. The optical units each include a light-emitting element that emits an infrared ray and a light-receiving element that receives an infrared ray. As illustrated in FIG. 3, a space above an operation screen 51a, which is the surface of the display 51, by a predetermined distance from the operation screen 51a serves as a detection surface 53a for detecting a touchless operation of the user for the operation screen 51a. The detection surface 53a extends in a direction in which the light-emitting elements emit infrared rays. The user's finger enters the detection surface 53a to reflect the infrared rays emitted by the light-emitting elements. The diffused reflected light of the infrared rays is received by multiple light-receiving elements. Based on light intensities of the reflected infrared rays received by the respective light-receiving elements, the touchless sensor 53 detects the position of the fingertip.

A touchless sensor in the related art includes two-axis scanning light paths, i.e., a scanning light path of infrared rays emitted in a height direction of a display and a scanning light path of infrared rays emitted in a width direction of the display. The touchless sensor in the related art includes an array of light-emitting elements at one end of the display and an array of light-receiving elements at an opposite end of the display. The finger enters a detection surface to block light from the light-emitting elements, so that some light-receiving elements no longer receive the light. Based on positions of such light-emitting elements, the touchless sensor in the related art detects the position of the fingertip. For this reason, the touchless sensor in the related art includes a frame body surrounding the display. This sometimes makes an operation difficult at the ends of the operation screen, causing an issue in operability. An issue of the deterioration of the appearance also arises.

In contrast, the touchless sensor 53 illustrated in FIGS. 2 and 3 includes a one-axis scanning light path, i.e., a scanning light path of infrared rays emitted from the far side of the operation panel 50 in the height direction of the display 51 (i.e., a front-rear direction of the image forming apparatus 1 or a Y-direction in FIGS. 2 and 3). The infrared rays reflected and diffused toward the far side of the operation panel 50 by the user's finger that has entered the detection surface 53a are received by the light-receiving elements, so that the touchless sensor 53 detects the position of the fingertip. Thus, it is sufficient to dispose the touchless sensor 53 according to the present embodiment on the far side of the operation panel 50. This can improve the operability at the ends of the operation screen as compared with the touchless sensor in the related art surrounding the display. The deterioration of the appearance does not occur. In the present embodiment, the above-described touchless sensor in the related art may be used as an alternative to the touchless sensor 53 illustrated in FIGS. 2 and 3.

FIG. 4 is a functional block diagram of the operation panel 50. The operation panel 50 having a sixth or seventh configuration example (described below) includes an additional touchless sensor 72 or 73 indicated by an imaginary line in FIG. 4.

As illustrated in FIG. 4, the operation panel 50 includes the panel controller 55 including a computer device such as a microcomputer. The panel controller 55 includes a central processing unit (CPU) 55a. The panel controller 55 also includes a random access memory (RAM) 55b and a read-only memory (ROM) 55c each serving as a memory connected to the CPU 55a through a bus line. The CPU 55a executes a control program, which is a preinstalled computer program, to control the display 51 and detect a user operation based on position information on the position detected by the touchless sensor 53 or the touch panel 52 and an operation screen displayed on the display 51. The ROM 55c stores fixed data such as a computer program and control data in advance. The RAM 55b functions as a work area or the like that stores various kinds of data in a rewritable manner.

As described above, the touch panel 52 has the detection surface for detecting a touch, and detects a touched position in response to a user's finger or the like touching the detection surface. The position information on the position detected by the touch panel 52 is sent to the panel controller 55. Based on the position information on the position detected by the touch panel 52, the panel controller 55 detects a touch operation on the operation screen displayed on the display 51.

As described above, the user's finger enters the detection surface 53a to reflect the infrared rays emitted by the light-emitting elements. The diffused reflected light of the infrared rays is received by the multiple light-receiving elements. Based on light intensities of the reflected infrared rays received by the respective light-receiving elements, the touchless sensor 53 detects the position of the fingertip. The position information on the position detected by the touchless sensor 53 is sent to the panel controller 55. Based on the position information on the position detected by the touchless sensor 53, the panel controller 55 detects a touchless operation for the operation screen displayed on the display 51.

Based on the detected operation performed by the user on the operation screen, the panel controller 55 identifies information related to an image forming operation input through the user operation, and sends the identified information related to the image forming operation to a main body controller 56 (i.e., a controller of the image forming apparatus).

The display displays an operation screen.

As described above, in the operation panel 50 according to the present embodiment, the touch panel 52, which corresponds to an touch input device to receive an operation of touch input based on a touch, is disposed to overlap the display 51 at least partially when viewed in a direction of a normal to the display 51. The operation panel 50 according to the present embodiment enables, via a touchless operation (touchless switching operation), switching between touchless input using the touchless sensor 53 and touch input using the touch panel 52. A touchless detector for detecting this touchless switching operation may be implemented using the touchless sensor 53 illustrated in FIG. 4, or using the additional touchless sensor 72 or 73 indicated by the imaginary line in FIG. 4.

A comparative example employs a two-step operation in which an operation for switching between touch input and touchless input starts in response to an operation on a main menu and ends in response to an operation on a setting screen. Specifically, a screen of the main menu displays an icon “Select touch panel” as well as icons of “Scan”, “Copy”, and “Fax”, which are functions of an image forming apparatus. Setting the icon “Select touch panel” on displays the setting screen. The setting screen displays an icon for selecting whether to enable the touch panel to receive a touch or enable the touchless operation unit. The switching operation is completed in response to an operation on this setting screen.

Likewise, in the present embodiment, the touchless switching operation may include two or more steps. Alternatively, the switching may be performed in a single step. For example, the switching is performed by a single-step operation as follows. Touch input is switched to touchless input in response to detection of the touchless switching operation at a predetermined location when touch input is enabled. Conversely, touchless input is switched to touch input in response to detection of the touchless switching operation at the predetermined location when touchless input is enabled.

FIG. 5 is a flowchart of control performed when the touchless switching operation is the single-step operation. This control is performed in response to detection of a unit including the touchless sensor 53 being electrically connected to the image forming apparatus 1, and ends in response to interruption of the electrical connection (N in S1).

In this control, it is determined whether the electrical connection is maintained (S1). When the unit including the touchless sensor 53 and the image forming apparatus 1 are in the connected state (Y in S1), it is determined whether the touchless switching operation is detected (S2). When the touchless switching operation is detected (Y in S2), touch input and touchless input are switched between. The default setting when the unit including the touchless sensor 53 is electrically connected to the image forming apparatus 1 for the first time may be either touch input or touchless input.

An input device includes a display (51), a touch input device (e.g., the touch panel 52), a touchless detector (e.g., the touchless sensor 53), and circuitry (e.g., the panel controller 55). The display (51) has a display face. The touch input device has a body and a touch region (e.g., the detection surface 53a) at least partially overlapping the display face of the display (51) when viewed from a normal direction normal to the display face of the display. The touch input device (52) receives a touch or a press to input operations in the touch region in a touch mode. The touchless detector is attached to the body of the touch input device and detects a touchless input in a touchless region covering a switching region (e.g., a touchless operation guide 71) outside the touch region in a touchless mode. The circuitry is configured to determine whether the touchless detector has detected the touchless input in the switching region, and switch from the touch mode to the touchless mode when it is determined that the touchless detector has detected the touchless input as a switching operation.

The operation panel 50 according to the present embodiment has a feature in a setting of an operation location of the touchless switching operation to be detected by the touchless sensor 53, that is, a set location of the detection surface 53a of the touchless sensor 53 for the touchless switching operation. In the present embodiment, the detection surface 53a of the touchless sensor 53 for the touchless switching operation is set such that the touchless switching operation is detectable at a predetermined location that does not overlap the touch input device (i.e., the touch panel 52) when viewed in a direction of the normal to the operation screen 51a, which is the surface of the touch panel 52 that is the touch input device to receive touch input. The predetermined location is a location where the touchless sensor 53 detects the touchless switching operation, and thus can be referred to as a touchless switching operation detection location.

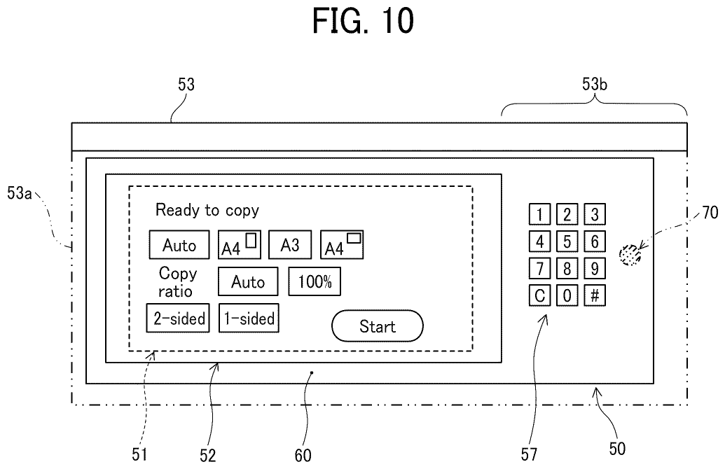

The touchless sensor 53 (or 72 or 73) that implements the touchless detector is attached to the main body of the operation panel 50 such that the touchless switching operation detection location is in the detection surface 53a. When the operation panel 50 includes, on the main body of the operation panel 50, physical hardware keys that generate electric signals in response to pressing (see hardware keys 57 in FIG. 10) in addition to the touch panel 52, the touchless switching operation detection location (touchless switching operation surface) is set so as not to overlap the touch input device also including the hardware keys.

An input device includes an operation panel. The operation panel includes a display to display information related to image formation; a touch operation device disposed above the display to generate input information in response to a touch or pressing on a surface of the touch operation device; a fixing portion to which the touch operation device is attached; a touchless sensor attached to the operation panel to detect a position of a finger in a touchless manner; a touchless detection surface to detect a position of an object with the touchless sensor; and a touchless switching operation surface where a touch/touchless switching operation is performed in a touchless manner. The touchless switching operation surface is located outside the touch operation device.

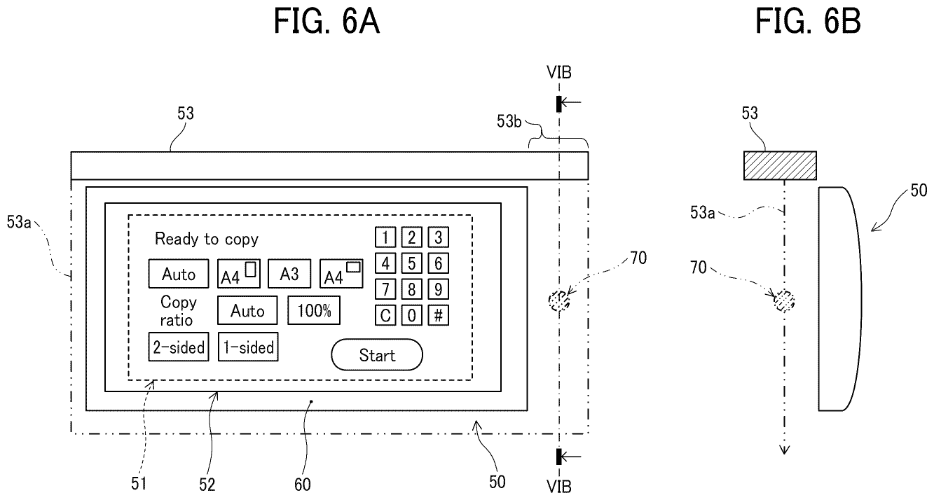

FIGS. 6A to 12 illustrate configuration examples of the operation panel 50 in which the touchless switching operation detection location is set differently from one another. The operation panel 50 of a configuration example (first configuration example) illustrated in FIGS. 6A and 6B has the front cover 60 that serves as a fixing portion to which the touch panel 52, which serves as a touch operation device to generate input information in response to a touch, is fixed. An outer peripheral edge of the front cover 60 serves as an outer peripheral edge of the main body of the operation panel 50 when viewed in the direction of the normal to the operation screen 51a. That is, the front cover 60 is regarded as a fixing frame of the touch panel 52 when viewed in the normal direction. FIG. 6A is a front view of the operation panel 50. FIG. 6B is a cross-sectional view taken along line VIB-VIB in FIG. 6A.

In the first configuration example, a touchless switching operation detection location 70 indicated by an imaginary line is set to be located in a space outside the fixing frame of the main body of the operation panel 50. The touchless sensor 53 has an extended portion 53b, which allows the touchless switching operation detection location 70 to be located in the detection surface 53a.

Information illustrated in the display 51 in FIG. 6A is an example of information related to image formation that is displayed by a display. The information includes icons (including icons of numerical keys) for indicating locations of input using the touch panel 52 and information indicating the state of the image forming apparatus 1.

In the present embodiment, the touchless sensor 53 that detects a finger or an object is installed on an upper surface side of the operation panel 50. However, the configuration is not limited to this example, and the touchless sensor 53 may have a structure surrounding the operation panel 50. In this configuration example, an operation for switching between touch input and touchless input is performed in midair.

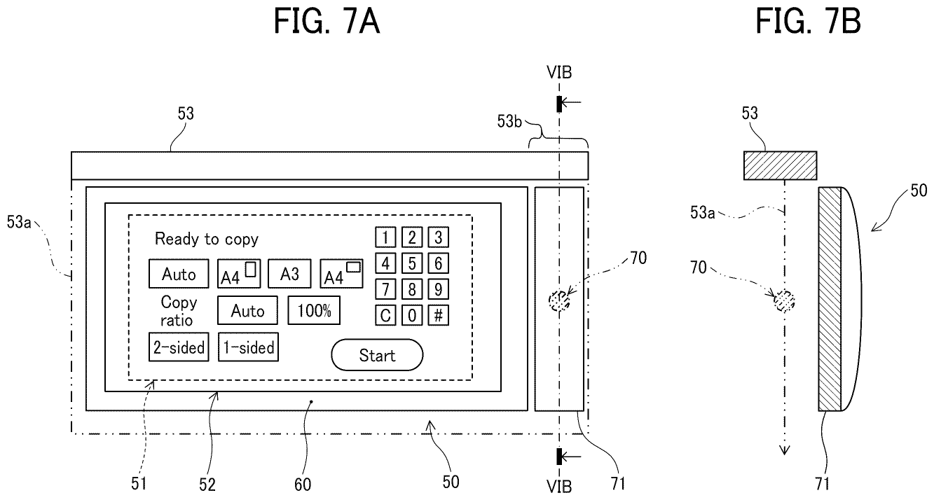

FIGS. 7A and 7B illustrate another configuration example (second configuration example) of the operation panel 50. In contrast to the first configuration example, in the second configuration example, a touchless operation guide 71 is further provided. The touchless operation guide 71 is provided with a printed indicator or a light-emitting diode (LED) for indicating the touchless switching operation detection location 70 indicated by the imaginary line. For example, a circular marking indicated by an imaginary line or text such as “Switch input” is printed at the touchless switching operation detection location 70 indicated by the imaginary line. The touchless operation guide 71 facilitates the position identification of the touchless switching operation detection location 70.

The touchless detector includes a guide marking of the switching operation in the switching region.

The touchless operation guide 71 is a separate body from the main body of the operation panel 50. The touchless operation guide 71 may be attached to and supported by the main body (e.g., the front cover 60) of the operation panel 50. Alternatively, the touchless operation guide 71 may be directly attached to and supported by the image forming apparatus 1 to which the touchless sensor 53 and the operation panel 50 are attached.

FIGS. 8A and 8B illustrate still another configuration example (third configuration example) of the operation panel 50. In the third configuration example, components such as the front cover 60 serving as the fixing portion are extended, so that the touchless switching operation detection location 70 is set above the fixing portion in a direction of a normal to the fixing portion. An extended portion 60a of the fixing portion may include an object for guiding a touchless operation. The object may include a printed indicator or an LED for indicating the touchless switching operation detection location 70. For example, the aforementioned printed indicator or LED is provided at the touchless switching operation detection location 70 indicated by the imaginary line.

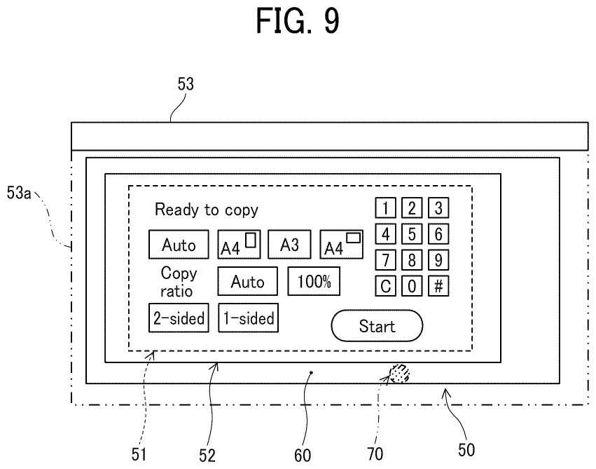

FIG. 9 illustrates still another configuration example (fourth configuration example) of the operation panel 50. As illustrated in FIG. 9, the touchless switching operation detection location 70 may be set on a near side of the fixing portion (i.e., the front cover 60).

The aforementioned printed indicator or LED may be provided also at this location.

The touchless detector detects the touchless input in the switching region outside the touch region in the body.

FIG. 10 illustrates still another configuration example (fifth configuration example) of the operation panel 50. In the fifth configuration example, the operation panel 50 includes, as the touch operation device, the touch panel 52 and the hardware keys 57 (e.g., numerical keys). Since a peripheral area of the hardware keys 57 also serves as the fixing portion, the touchless switching operation detection location 70 may be set in the peripheral area of the hardware keys 57. The aforementioned printed indicator or LED may be provided at the touchless switching operation detection location 70 indicated by the imaginary line.

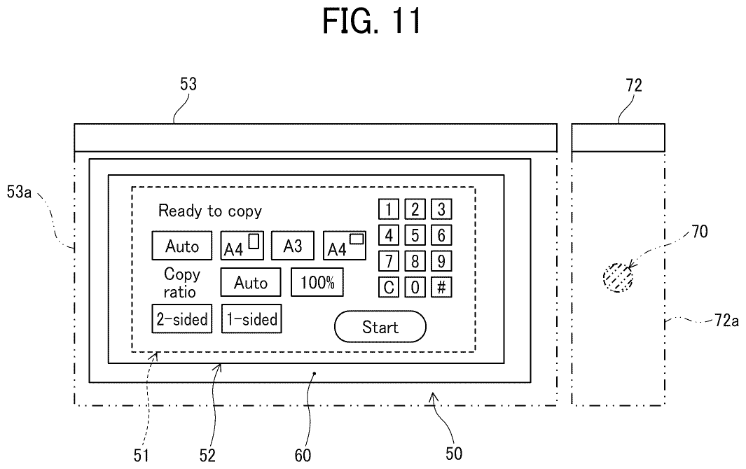

FIG. 11 illustrates still another configuration example (sixth configuration example) of the operation panel 50. In the sixth configuration example, the operation panel 50 further includes the additional touchless sensor 72 that is a separate body from the touchless sensor 53 for detecting touchless input. The touchless sensor 72 performs detection at the touchless switching operation detection location 70 in a detection surface 72a. For example, a low-cost sensor such as a photoelectric sensor that detects blocking of light by a finger or an object may be used as the additional touchless sensor 72 rather than a sensor that detects the coordinates of the position such as the touchless sensor 53. This enables the detection surface 72a for switching and the touchless switching operation detection location 70 to be set at low cost. The additional touchless sensor 72 may be attached to an area of the image forming apparatus main body 3 near the operation panel 50 rather than the operation panel 50.

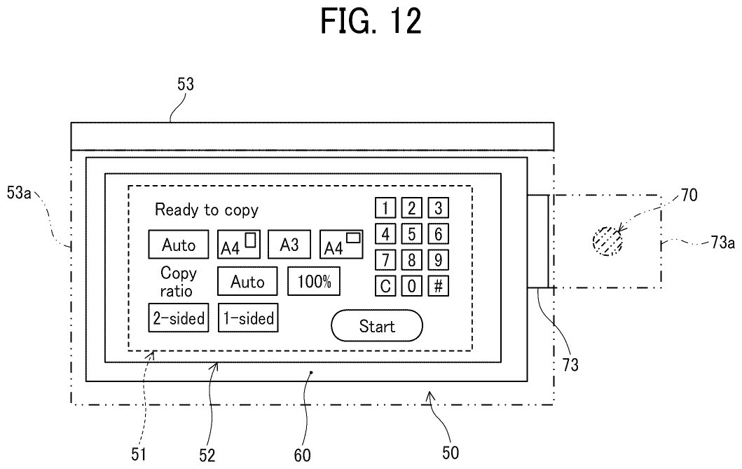

FIG. 12 illustrates still another configuration example (seventh configuration example) of the operation panel 50. In the seventh configuration example, the additional touchless sensor 73 that is a separate body from the touchless sensor 53 for detecting touchless input is installed in a side face portion of the operation panel 50. Specifically, the additional touchless sensor 73 is installed to make a space in a direction of the normal to the side face portion of the operation panel 50 be a detection surface 73a including the touchless switching operation detection location 70. In the configuration examples illustrated in FIGS. 6A to 8B and 11, the touchless sensor 53 for detecting touchless input may be extended to have a large width, for example. This may increase the size of the operation panel 50. In contrast, in the seventh configuration example, the additional touchless sensor 73 is installed in the side face portion of the operation panel 50. This enables the detection surface 73a and the touchless switching operation detection location 70 to be set without increasing the size of the operation panel 50.

The input device further includes another touchless detector attached to the body of the touch input device. Said another touchless detector is separated from the touchless detector, and adjacent to the touchless detector.

While preferable embodiments of the present disclosure have been described above, the present disclosure is not limited to specific embodiments and may be variously modified and altered within the scope of the spirit of the present disclosure written in the claims unless particularly limited in the description above.

For example, in the embodiments described above, in the attachment of the touchless sensor 53 or the like that implements the touchless detector to the main body of the operation panel 50, the touchless sensor 53 is retrofitted, using an attachment structure, to the main body of the operation panel 50 that is a completed body including an assembly of components. In other embodiments, in the production phase of the main body of the operation panel 50, the touchless sensor 53 is assembled similarly to the components of the operation panel 50. The touchless sensor 53 has already been attached to the operation panel 50 at the completion.

The embodiments described above are an example in which the present disclosure is applied to the input device of the image forming apparatus. However, the application of the present disclosure is not limited to this example, and the present disclosure is applicable to input devices of various electronic devices. The effects described in the embodiments of the present disclosure are merely the most preferable effects resulting from the present disclosure, and the effects of the present disclosure are not limited to those described in the embodiments of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The above description is an example, and the present disclosure exhibits specific effects according to each aspect below. In the description of each aspect, the reference signs in parentheses following the component names each indicate an example of a corresponding member, and the components are not limited to these specific examples.

According to Aspect 1, an input device (50) that enables switching between touchless input and touch input includes a display (51) and an touch input device (52, 71). The touch input device (52, 71) is disposed to overlap the display (51) at least partially when viewed in a direction of a normal to the display (51), to receive an operation of the touch input based on a touch or pressing. A touchless detector (53b, 72, 73) is attached to a main body of the input device (50) to detect a touchless switching operation that is a touchless operation for the switching. The touchless switching operation is performed at a predetermined location that does not overlap the touch input device (52, 71) when viewed in a direction of a normal to the touch input device (52, 71).

Thus, an area of the display (51) is not consumed for a touchless switching operation.

A comparative example presents an image forming apparatus equipped with an input device that switches between a touch mode in which input is performed using a touch panel and a touchless mode in which input is performed using a touchless operation unit. A reader such as a radio frequency identifier (RFID) reader is installed at a portion of the main body of the image forming apparatus different from the position of the input device. The reader reads an approach of a storage medium such as an integrated circuit (IC) card. In this manner, the input device performs the switching. Thus, the reader is installed separately from the input device, and a switching operation is performed for the reader located at the position separate from the input device. In contrast, when an optical detection sensor is used as the touchless detector according to the embodiments of the present disclosure, the cost can be reduced relative to the cost of using the RFID reader.

According to Aspect 2, in the input device (50) according to Aspect 1, the touchless detector (53b, 72, 73) is implemented using a sensor (53) attached to the main body of the input device (50) and implementing a touchless input detector that detects an operation of the touchless input.

Thus, a single sensor (53) serving as both the touchless input detector and the touchless detector (53b, 72, 73) is attached to the main body of the input device (50) in contrast to the case where the touchless input detector and the touchless detector (53b, 72, 73) are separately attached to the main body of the input device (50). This makes the attachment work easier.

The touchless detector includes a sensor to detect the touchless input in the touchless region covering the touch region and the switching region adjacent to the touch region.

In Aspect 2, it can be said that the touchless detector (53b, 72, 73) is attached such that the predetermined location is located within the touchless input operation detection surface for detecting an operation of touchless input. The touchless detector (53b, 72, 73) may be implemented by extending (i.e., increasing the size of) the sensor (53) of the touchless input detector that detects touchless input so that the sensor (53) can perform detection up to a location that does not overlap the touch input device (52, 71) in the perpendicular direction of the detection surface, or by using a high-performance sensor that can perform detection up to a location that does not overlap the touch input device (52, 71) in the perpendicular direction of the detection surface as the sensor (53) of the touchless input detector that detects touchless input.

According to Aspect 3, in the input device (50) of Aspect 1, the touchless detector (53b, 72, 73) is attached such that the predetermined location is located in a space above a surface of the main body of the input device (50) in a direction of a normal to the surface, the surface being on a side of the main body of the input device (50) where the touch input device (52, 71) is located.

Thus, the surface of the main body of the input device (50) on the side on which the touch input device (52, 71) is located is usable as the background of the predetermined location. In Aspect 1, the predetermined location is set in a midair space where no object is located nearby. In contrast, in Aspect 3, the predetermined location is limited to an area where an object, i.e., the main body of the input device (50) is located on the far side.

According to Aspect 4, in the input device (50) of Aspect 1, the touchless detector (53b, 72, 73) is attached separately from a touchless input detector that detects an operation of the touchless input.

Thus, the touchless input detector and the touchless detector (53b, 72, 73) can be separately installed and sensors each having desired performance can be used. This implements a system configured at low cost. Specifically, a low-cost sensor such as a photoelectric sensor that detects blocking of light instead of detecting coordinates of the position is usable as the sensor of the touchless detector (53b, 72, 73), unlike the sensor (53) of the touchless input detector.

According to Aspect 5, in the input device (50) of Aspect 1, a guide marking for the touchless switching operation is disposed to overlap the predetermined location.

Thus, the guide marking is usable as a reference, making the touchless switching operation easier.

According to Aspect 6, in the input device (50) of Aspect 1, the display (51) displays an operation screen.

Thus, the operation screen on the display 51 is usable as an operation guide for touchless input.

According to Aspect 7, an input device (50) includes an operation panel. The operation panel includes a display (51), a touch operation device (52, 71), a fixing portion, a touchless sensor (53), a touchless detection surface (53a), and a switching operation surface (70). The display (51) displays information related to image formation. The touch operation device (52, 71) is disposed above the display (51) to generate input information in response to a touch or pressing on a surface of the touch operation device (52, 71). To the fixing portion, the touch operation device (52, 71) is attached. The touchless sensor (53) is attached to the operation panel to detect a position of a finger in a touchless manner. The touchless detection surface (53a) detects a position of an object with the touchless sensor (53). In the touchless switching operation surface (70), a touch/touchless switching operation is performed in a touchless manner. The touchless switching operation surface (70) is located outside the touch operation device (52, 71).

Thus, an area of the display (51) is not consumed for a touchless switching operation.

According to Aspect 8, in the input device (50) of Aspect 1, the touchless switching operation surface (70) is located within the touchless detection surface (53a).

Thus, a single sensor (53) serving as both the touchless input detector (53) and the touchless detector (53b, 72, 73) is attached to the main body of the input device (50) in contrast to the case where the touchless input detector (53) and the touchless detector (53b, 72, 73) are separately attached to the main body of the input device (50). This makes the attachment work easier.

According to Aspect 9, in the input device (50) of Aspect 1, the touchless switching operation surface (70) is located above a surface of the fixing portion (60) or in a space in a direction of a normal to the fixing portion (60).

Thus, the surface of the main body of the input device (50) on the side on which the touch input device (52, 71) is located is usable as the background of the predetermined location.

According to Aspect 10, an image forming apparatus includes an input device (50). The input device (50) is the input device (50) according to any one of Aspects 1 to 9.

Thus, an area of the display (51) is not consumed for a touchless switching operation.

1. An input device comprising:
a display having a display face; and
a touch input device having:
a body; and
a touch region at least partially overlapping the display face of the display when viewed from a normal direction normal to the display face of the display,
the touch input device to receive a touch or a press to input operations in the touch region in a touch mode; and
a touchless detector attached to the body of the touch input device to:
detect a touchless input in a touchless region covering a switching region outside the touch region in a touchless mode; and
circuitry configured to:
determine whether the touchless detector has detected the touchless input in the switching region; and
switch from the touch mode to the touchless mode when it is determined that the touchless detector has detected the touchless input as a switching operation.

2. The input device according to claim 1, wherein:
the touchless detector includes a sensor to detect the touchless input in the touchless region covering:
the touch region; and
the switching region adjacent to the touch region.

3. The input device according to claim 1, wherein:
the touchless detector detects the touchless input in the switching region outside the touch region in the body.

4. The input device according to claim 1, further comprising another touchless detector attached to the body of the touch input device,
said another touchless detector is:
separated from the touchless detector; and
adjacent to the touchless detector.

5. The input device according to claim 1, wherein:
the touchless detector includes a guide marking of the switching operation in the switching region.

6. The input device according to claim 1, wherein:
the display displays an operation screen.

7. An input device comprising:
an operation panel including:
a display to display information related to image formation;
a touch operation device disposed above the display to generate input information in response to a touch or pressing on a surface of the touch operation device;
a fixing portion to which the touch operation device is attached;
a touchless sensor attached to the operation panel to detect a position of a finger in a touchless manner;
a touchless detection surface to detect a position of an object with the touchless sensor; and
a touchless switching operation surface where a touch/touchless switching operation is performed in a touchless manner, wherein
the touchless switching operation surface is located outside the touch operation device.

8. The input device according to claim 7, wherein:
the touchless switching operation surface is located within the touchless detection surface.

9. The input device according to claim 7, wherein:
the touchless switching operation surface is located above a surface of the fixing portion or in a space in a direction of a normal to the fixing portion.

10. An image forming apparatus comprising:
the input device according to claim 1.

11. An image forming apparatus comprising:
the input device according to claim 7.
